(19) United States
(12) Patent Application Publication
(10) Pub. No.: US 2023/0195819 A1
(43) Pub. Date: Jun. 22, 2023

(54) MACHINE LEARNING-BASED USER SELECTION PREDICTION BASED ON SEQUENCE OF PRIOR USER SELECTIONS

(71) Applicant: Home Depot Product Authority, LLC, Atlanta, GA (US)

(72) Inventors: Walid Shalaby, Los Gatos, CA (US); Srivatsa Mallapragada, Atlanta, GA (US); Ying Xie, Marietta, GA (US); Xiquan Cui, Brookhaven, GA (US); Khalifeh Al Jadda, Suwanee, GA (US)

(21) Appl. No.: 18/084,324

(22) Filed: Dec. 19, 2022

Related U.S. Application Data
(60) Provisional application No. 63/291,793, filed on Dec. 20, 2021.

(51) Int. Cl. G06F 16/954; G06F 40/284; G06N 20/00

(52) U.S. Cl. CPC G06F 16/954; G06F 40/284; G06N 20/00

(57) ABSTRACT

A method for predicting a next user selection in an electronic user interface, such as a website, includes training a machine learning model according to a training data set, the training data set including a plurality of token sets, each token set representative of a respective document accessible through the interface, each token set including a plurality of words, each word describing a characteristic of the document, to create a trained model. The method further includes receiving, from a user, a sequence of selections of documents, inputting the sequence of selections to the trained model, and outputting to the user, in response to the sequence of selections, a predicted next document selection according to an output of the trained model.

### CROSS-REFERENCE TO RELATED APPLICATION

This application claims priority to U.S. Provisional Application No. 63/291,793, filed Dec. 20, 2021, which application is hereby incorporated by reference in its entirety.

### TECHNICAL FIELD

This disclosure generally relates to prediction of a next user action in an electronic interface given a sequence of prior user actions, including a particular training approach for a machine learning model for such predictions.

### BACKGROUND

Predictions of website user behavior may be utilized in numerous ways. For example, a user’s browsing sequence may be used to predict (and therefore recommend) the user’s next desired browsing action. In another example, a user’s purchase sequence may be used to predict (and therefore recommend) a next products for the user.

### BRIEF DESCRIPTION OF THE DRAWINGS

FIG. 1 is a diagrammatic view of an example system for providing a recommendation to a user based on a sequence of actions of the user.

FIG. 2 is a flow chart illustrating an example method of providing a recommendation to a user based on a sequence of actions of the user.

FIG. 3 is a flow chart illustrating an example method of training a machine learning model to predict a next user action given an input sequence of user actions.

FIG. 4 illustrates a portion of an example machine learning model training round.

FIG. 5 illustrates a portion of an example machine learning model training round.

FIG. 6 is a diagrammatic view of an example embodiment of a user computing environment.

### DETAILED DESCRIPTION

Known sequential recommendation systems do not adequately utilize substantive information about the subjects of user behavior (i.e., documents and their contents or subjects) in either training data or in live recommendations. A novel sequential recommendation system according to the present disclosure may improve upon known systems and methods by utilizing information about of the subject of documents, such as by training a machine learning model on such information, to generate more accurate predictions of a next user action.

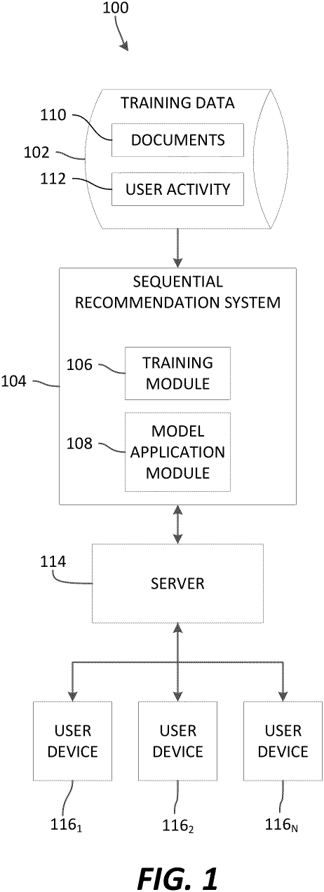

Referring now to the drawings, wherein like numerals refer to the same or similar features in the various views, FIG. 1 is a diagrammatic view of an example system 100 for providing a recommendation to a user based on a sequence of actions of the user. The system 100 may include a training data source 102 and a sequential recommendation system 104 that may include one or more functional modules 106, 108 embodied in hardware and/or software. In an embodiment, the functional modules 106, 108 of the sequential recommendation system 104 may be embodied in a processor and a memory (i.e., a non-transitory, computer-readable medium) storing instructions that, when executed by the processor, cause the processor to perform the functionality of one or more of the functional modules and/or other functionality of this disclosure.

The training data source 102 may include a set of documents 110 and records of user activity 112. In some embodiments, the documents 110 may be documents specific to or otherwise accessible through a particular electronic user interface, such as a website or mobile application. The user activity 112 may be user activity on the electronic user interface, such as user navigations to the documents, user selections of the subjects of the documents, etc. For example, in some embodiments, the documents 110 may be respective of products and services offered through an e-commerce website (e.g., where each documents is respective of a given product or service), and the user activity 112 may be user interactions with the documents themselves (e.g., user navigations to, clicks on, or examinations of the documents), and/or user interactions with the products and services that are the subjects of those documents (e.g., purchases, additions to cart, etc.).

The functional modules 106, 108 of the sequential recommendation system 104 may include a training module 106 that is configured to train one or more machine learning models using the training data 102. For example, in some embodiments, the training module 106 may train a machine learning module using the documents 110 to enable the machine learning module to learn the vocabulary of the documents, and may train the machine learning model using the user actions 112 to enable the model to recognize and predict sequences of user actions based on the contents of the documents 110 associated with those user actions.

The functional modules 106, 108 may also include a model application module 108 that may use the trained machine learning model to, given an input of a sequence of user actions, predict the most likely next user action. For example, the trained machine learning model may be applied in conjunction with a website to recommend a next document to a user based on that user’s sequence of actions on the website. In some embodiments, the trained machine learning model may receive a sequence of products and/or services that a user interacts with, such as by viewing, adding to cart, or purchasing, and may output a predicted product or service, or the characteristics of a predicted product or service, based on that sequence.

The system 100 may further include a server 114 in electronic communication with the sequential recommendation system 104 and with a plurality of user computing devices 116₁, 116₂, ... 116_{N}. The server 114 may provide a website, data for a mobile application, or other interface through which the users of the user computing devices 116 may navigate and otherwise interact with the documents 110. In some embodiments, the server 114 may receive a sequence of user actions through the interface, provide the sequence of user actions to the sequential recommendation system 104, receive a next document prediction from the sequential recommendation system 104, and provide the next document prediction to the user (e.g., through the interface).

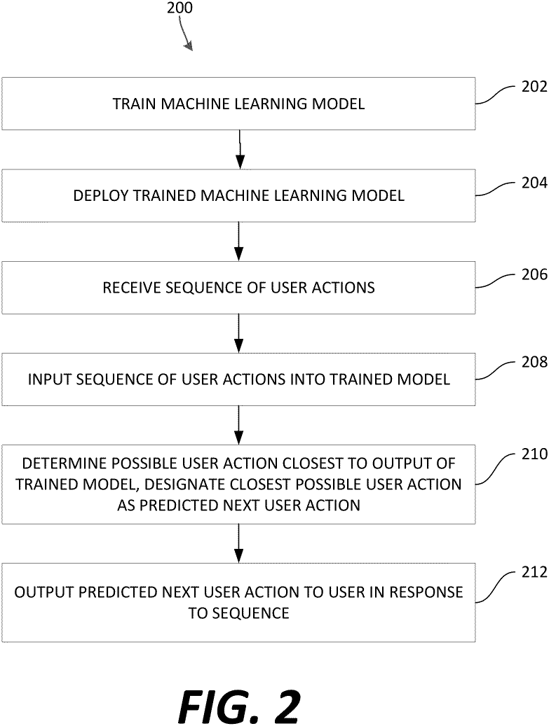

FIG. 2 is a flow chart illustrating an example method of providing a recommendation to a user based on a sequence of actions of the user. The method 200, or one or more portions of the method 200, may be performed by the system 100, and more particularly by the sequential recommendation system 104, in some embodiments.

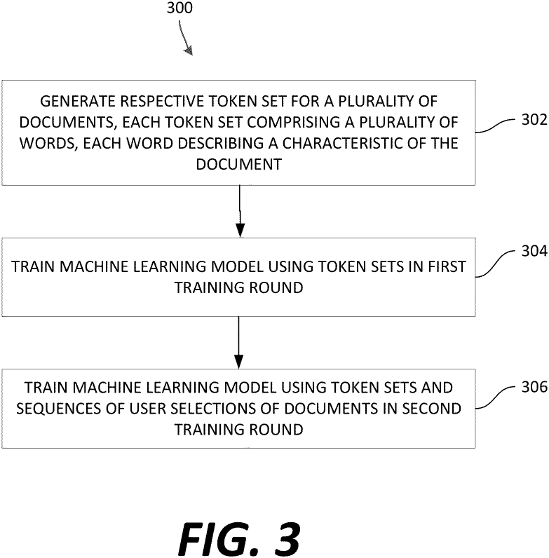

The method 200 may include, at block 202, training a machine learning model. The machine learning model may be trained to receive, as input, a sequence of user actions and to output a predicted next user action, or one or more characteristics of the predicted next user action. For example, in some embodiments, the machine learning model may be trained to accept a sequence of documents and to output one or more characteristics of a predicted next document. In a further example, the machine learning model may be trained to accept a sequence of products and/or services available on an e-commerce website and to output a predicted next product or service or one or more characteristics of a predicted next product or service. An example method of training a machine learning algorithm will be described below with respect to the method 300 of FIG. 3.

Training the machine learning model at block 202 may be performed using a set of training data that may include, for example, documents accessible through a given interface, such as a website or mobile application. The documents may be, for example, individual web pages, information pages for respective products or services, spreadsheet or database rows, text lines, etc. The training data may further include user activity through the interface, such as interaction with the documents and/or their contents or subject, that occurred before training.

The method 200 may further include, at block 204, deploying the trained machine learning model. The trained machine learning model may be deployed in conjunction with a website or mobile application, such as the website or mobile application with which the training data is associated. After deployment, each user’s sequence of actions on the interface may be analyzed according to the trained machine learning model, and output based on the trained machine learning model may be provided to the user through the interface.

The method 200 may further include, at block 206, receiving a sequence of user actions. The sequence of user actions may be a user’s interactions with the interface with which the training data used at block 202 is associated. For example, the user actions may be a sequence of documents that the user selects (e.g., clicks), navigates to, scrolls, or the contents (e.g., products and/or services) of which documents the user purchases, adds to cart, etc.

The method 200 may further include, at block 208, inputting the sequence of user actions into the deployed trained model. In some embodiments, each new user action may be input to the trained model, such that the trained model is predicting a next user action in response to each new user action, based on the sequence of prior user actions. The sequence of user actions may be of a defined length, in some embodiments. For example, in some embodiments, up to three prior user actions, in sequence, may be input to the model. In another example, all user actions within a single browsing session, or within a given time frame (e.g., one day), may be input to the model. In another example, up to a predetermined number of user actions (e.g., up to 50 user actions) without an intervening gap between actions that is greater than a threshold (e.g., a gap of one day or more between user actions may result in a new sequence of user actions) may be input to the model.

In response to the input sequence of user actions, the machine learning model may output a predicted next user action, or one or more characteristics of the predicted next user action. For example, the machine learning model may output one or more characteristics (e.g., a plurality of characteristics) of a predicted next document, such as one or more characteristics of a product or service that is the subject of the predicted next document. For example, in an embodiment in which the documents are respective of products and services, the machine learning model may output words (e.g., unique attributes) that describe a predicted next product or service.

The method 200 may further include, at block 210, determining a possible user action that is closest to the output of the trained machine learning model and designating the closest possible action as the predicted next user action. For example, in an embodiment in which the machine learning model outputs characteristics of a document, or of a product or service, block 210 may include determining the document, product, or service on the interface that is most similar to the characteristics output by the model. In a further example, where the model outputs embeddings, block 210 may include determining the document, product, or service having embeddings that are most similar to the embeddings output by the model.

In some embodiments, block 210 may include applying a nearest-neighbor algorithm to the model output to determine the closest available document, or product or service that is the subject of a document. For example, a nearest neighbor algorithm may be applied to words or other descriptors output by the model to find the most similar document or document subject. Additionally or alternatively, a cosine similarity function, hamming distance calculation, Levenshtein distance calculation, and/or another string-based or token-based similarity function may be applied to determine the most similar document embeddings to the model output embeddings.

The method 200 may further include, at block 212, outputting the predicted next user action to the user in response to the received sequence of user events. For example, the predicted next document, or product or service that is the subject of the predicted next document, may be output to the user in the form of a page recommendation, product recommendation, service recommendation, etc., through the electronic interface. In some embodiments, block 212 may include displaying a link to the predicted next document in response to a user search. In some embodiments, block 212 may include displaying a link to the predicted next document in response to a user navigation. In some embodiments, block 212 may include displaying a link to the predicted next document in response to a user click.

In some embodiments, blocks 206, 208, 210, and 212 may be performed continuously respective of a plurality of users of an electronic interface to provide next action predictions to each of those users, responsive to each user’s own activity. In some embodiments, predictions may be provided to a given user multiple times during the user’s browsing or use session, such that the prediction is re-determined for multiple successive user actions in a sequence.

FIG. 3 is a flow chart illustrating an example method of training a machine learning model to predict a next user action given an input sequence of user actions. The method 300, or one or more portions of the method 200, may be performed by the system 100, and more particularly by the sequential recommendation system 104, in some embodiments.

The method 300 may generally include conducting a first training round, at block 302, and a second training round, at block 304. Different portions of the same training data set may be used in the first and second training data rounds, in some embodiments.

The method 300 may include, at block 302, generating a respective token set for each of a plurality of documents, each token set comprising a plurality of words, each word describing a characteristic of the document. For example, a token set respective of a document may be a sequence of characteristics of a product or service that is the subject of the document. For example, for a document respective of a product, the token set for that document may include information such as a title, taxonomy, brand, color, manufacturer name, department name, and the like.

In some embodiments, block 302 may be performed for each of a plurality of documents accessible through a particular electronic interface, such as a website or mobile application. For example, where block 302 is performed with respect to a website offering products and/or services, where each good and service is associated with a respective information page document, a respective token set may be generated for each product and each service.

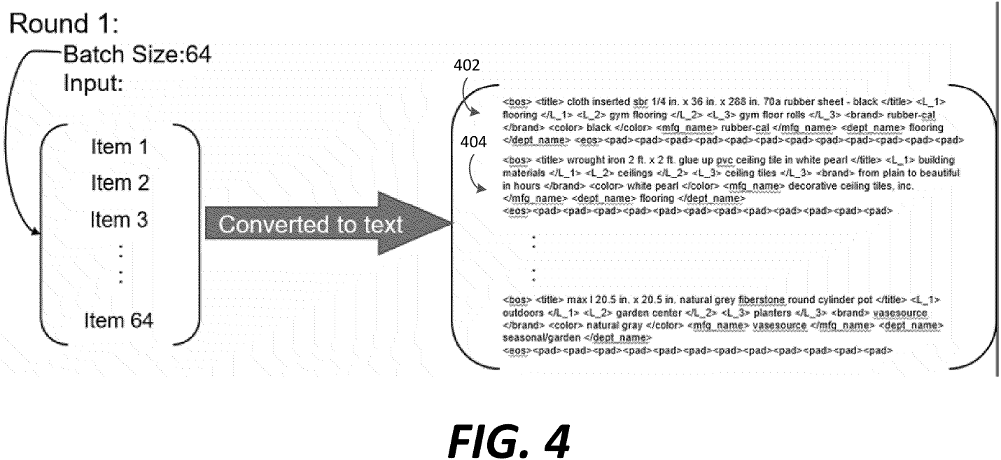

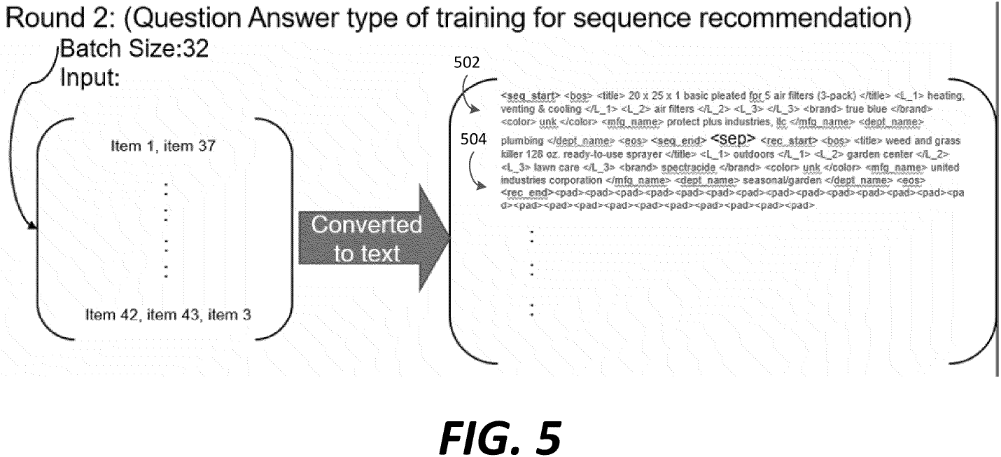

FIGS. 4 and 5 illustrate example token sets. In FIG. 4, a first token set 402 is generated for Item 1, a second token set 404 is generated for Item 2, and so on. Similarly, in FIG. 5, a first token set 502 is generated for Item 1 (though a different “Item 1” than in FIG. 4), and a second token set 504 is generated for Item 37, and so on.

The method 300 may further include, at block 304, training a machine learning algorithm using the token sets generated at block 302 in a first training round. FIG. 4 illustrates an example of block 304. As shown in FIG. 4, at block 304, the token set respective of a single document (e.g., where “Item 1” corresponds to a first document, “Item 2” corresponds to a second document, and so on), is input separately from other documents, and independent of user selections of documents (such user selections may be considered at block 306 below). At block 304, each of the token sets may be input to the model to enable the model to learn and recognize the vocabulary of the documents (i.e.,, the words of the document). In some embodiments, block 304 may include a plurality of training epochs, such that the model will have encountered each term in the tokens a plurality of times. Although FIG. 4 indicates a certain batch size for training (a batch size of 64 documents is indicated in FIG. 4), any appropriate batch size may be used. In some embodiments, block 304 may include all documents (that is, token sets associated with such documents) available in a particular electronic interface as training data. In some embodiments, such documents may include documents that have never been associated with user actions.

In some embodiments, training at block 304 may be performed according to equation (1) below. Given a set C of unique documents, the model may trained to predict the next token for each input token from T. Training can be modeled as a probability function to predict the next token with given set of previous tokens.

$$p \left(x\right) = {\prod }_{j = 1}^{n} p \left({t}_{j} \left|{t}_{1} , {t}_{2} , ... , {t}_{j - 1}\right)\right) , ∀ n = \left|c\right| , c ∈ C , a n d {t}_{j} ∈ T$$

The method 300 may further include, at block 306, training the machine learning algorithm using the token sets generated at block 302 in conjunction with sequences of user selections of documents to which those token sets relate. FIG. 5 illustrates an example of block 306. As shown in FIG. 5, at block 306, the token sets respective of multiple documents (e.g., where “Item 1” corresponds to a first document, “Item 37” corresponds to a second document, and so on), are input in a sequence in which those documents were selected by a user. At block 306, a large number of sequences may be input to enable the model to learn appropriate sequencing. In some embodiments, block 306 may include a plurality of epochs, such that the model will have encountered sequences in the training data a plurality of times. Although FIG. 5 indicates a certain batch size for training (a batch size of 32 sequences is indicated in FIG. 5), any appropriate batch size may be used. In some embodiments, sequences used at block 306 may be two, three, or four documents each. In other embodiments, other sequence sizes may be used as appropriate.

The training data may be modeled as a question-answer pair (Q; A) where the question is a token set sequence corresponding to a sequence of user-selected documents, and the answer is the token set corresponding to the last document in the user selection sequence. For example, consider a training data sequence having user actions A, B, C. In one training data pair, the model can take A, B as input is trained to produce C. In another training data pair, the model can take A and be trained to predict B. In general, for any given user sequence of length n, the sequence may be broken into n-1 subsequences and the targets/outputs will be all possible n-1 next items.

In some embodiments, training at block 306 may be performed according to equation (2) below. LetXbe the set of token set sequences where |X| is the size of the training data. Let x ∈ X be a specific token set sequence with |x| = n. Let the question be Q = {q_{1,} q₂, q_{3,}..., qₙ₋₁} where qᵢ ∈ C and the answer be a singleton set A = {a}, where a ∈ C.

$$p \left(x\right) = {\prod }_{i = 1}^{n} p \left(a \left|{q}_{1} , {q}_{2} , ... , {q}_{i - 1}\right)\right) , w h e r e n = \left|x\right|$$

Additionally or alternatively, in some embodiments, block 306 may be performed according to equation (1) above (e.g., where the input sequence consists of a single user action, rather than multiple user actions).

In some embodiments, new documents (i.e., documents not involved in training the model) may be added to the electronic interface. For many such documents, including but not limited to documents having terms and vocabulary that overlaps with documents on which the model was trained—the model may function appropriately (i.e., receiving such documents, or their subjects, as input, and/or predicting such documents as output) without further training. This ability—both to receive previously-unknown documents as input, and to predict previously-unknown documents as output, commonly referred to as the “cold start problem”—is an advance over known sequential recommendation approaches. The most common known approach inputs a plurality of characteristics of the sequence of documents to the model and the model produces a plurality of characteristics of the predicted next document. In contrast, the instant disclosure bases model input and output to sets of tokens, which can be compared (for degree of similarity) to information on which the model has not been trained to incorporate that untrained material into the predictive and input scope of the model.

In some embodiments, however, the model may be further trained on the new documents in order to improve the model performance by incorporating new documents in the training process, in which certain aspects of the method 300 may be repeated. For example, block 302 may be performed as to the new documents only, block 304 may be performed as to the new documents and a subset of the other documents, and block 306 may be performed as to a plurality of sequences involving the new documents, as well as other sequences.

Training a machine learning model according to method 300 may offer numerous advantages over known sequential prediction and recommendation approaches. First, creating token sequences from training data documents that reflect the characteristics of those documents, or of the subject of those documents, advantageously results in a model trained to recognize characteristics, rather than just document identifiers or other information that does not necessarily reflect the subject or contents of the documents. Second, training the model in two separate training rounds—one round including single documents, and a second round including user selection sequences of documents—ensures that the model both recognizes the entire vocabulary of the document set and that the model is trained on actual user selection sequences. Third, because the model is trained on token sets derived directly from individual documents— i.e., the token set of a given document is not determined based on information about any other document—when new documents are to be introduced to the system, additional training may not be necessary (if the vocabulary of the new documents is subsumed within previous documents) and, if needed, additional training can be performed on a small subset of new training data, without the need to generate new token sets for the entire training data set and completely retrain the model. In contrast, in some known training methodologies, document embeddings that are used to train the model are generated based on the entire document set, so introduction of additional documents after training requires regenerating embeddings for all documents and completely re-training the model. Fourth, because the model outputs a token set that can be compared to possible token sets to find the predicted next document, the model can predict and recommend a document that was not included in the model’s training, enabling the model to be continuously operational as new documents are added, without the need for additional training for each new document.

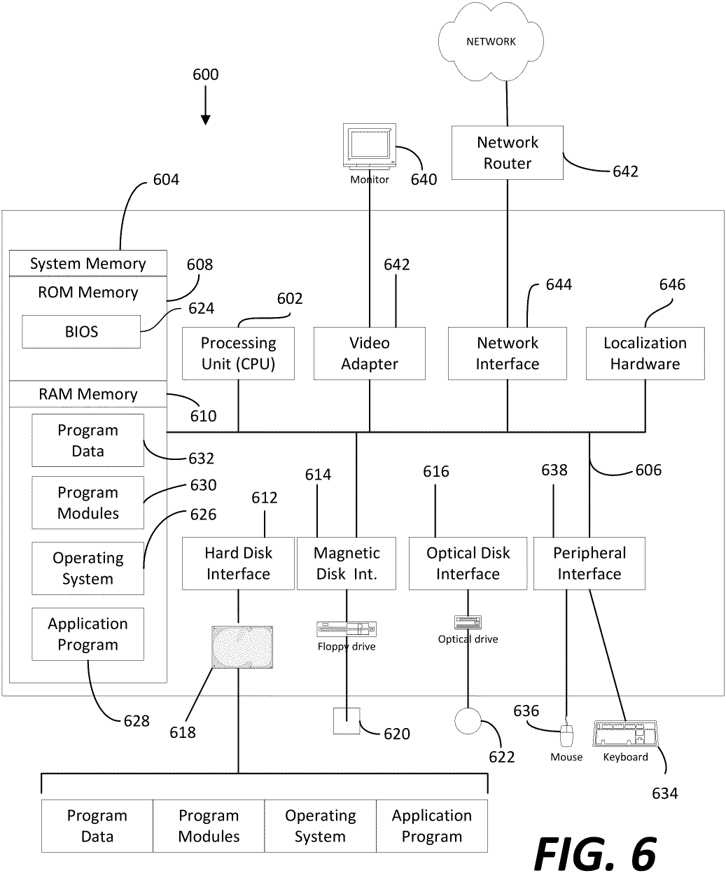

FIG. 6 is a diagrammatic view of an example embodiment of a user computing environment that includes a general purpose computing system environment 600, such as a desktop computer, laptop, smartphone, tablet, or any other such device having the ability to execute instructions, such as those stored within a non-transient, computer-readable medium. Furthermore, while described and illustrated in the context of a single computing system 600, those skilled in the art will also appreciate that the various tasks described hereinafter may be practiced in a distributed environment having multiple computing systems 600 linked via a local or wide-area network in which the executable instructions may be associated with and/or executed by one or more of multiple computing systems 600.

In its most basic configuration, computing system environment 600 typically includes at least one processing unit 602 and at least one memory 604, which may be linked via a bus 606. Depending on the exact configuration and type of computing system environment, memory 604 may be volatile (such as RAM 610), non-volatile (such as ROM 608, flash memory, etc.) or some combination of the two. Computing system environment 600 may have additional features and/or functionality. For example, computing system environment 600 may also include additional storage (removable and/or non-removable) including, but not limited to, magnetic or optical disks, tape drives and/or flash drives. Such additional memory devices may be made accessible to the computing system environment 600 by means of, for example, a hard disk drive interface 612, a magnetic disk drive interface 614, and/or an optical disk drive interface 616. As will be understood, these devices, which would be linked to the system bus 606, respectively, allow for reading from and writing to a hard disk 618, reading from or writing to a removable magnetic disk 620, and/or for reading from or writing to a removable optical disk 622, such as a CD/DVD ROM or other optical media. The drive interfaces and their associated computer-readable media allow for the nonvolatile storage of computer readable instructions, data structures, program modules and other data for the computing system environment 600. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 600.

A number of program modules may be stored in one or more of the memory/media devices. For example, a basic input/output system (BIOS) 624, containing the basic routines that help to transfer information between elements within the computing system environment 600, such as during start-up, may be stored in ROM 608. Similarly, RAM 610, hard drive 618, and/or peripheral memory devices may be used to store computer executable instructions comprising an operating system 626, one or more applications programs 628 (which may include the functionality of the category prediction system 104 of FIG. 1 or one or more of its functional modules 106, 108, for example), other program modules 630, and/or program data 622. Still further, computer-executable instructions may be downloaded to the computing environment 600 as needed, for example, via a network connection.

An end-user may enter commands and information into the computing system environment 600 through input devices such as a keyboard 634 and/or a pointing device 636. While not illustrated, other input devices may include a microphone, a joystick, a game pad, a scanner, etc. These and other input devices would typically be connected to the processing unit 602 by means of a peripheral interface 638 which, in turn, would be coupled to bus 606. Input devices may be directly or indirectly connected to processor 602 via interfaces such as, for example, a parallel port, game port, firewire, or a universal serial bus (USB). To view information from the computing system environment 600, a monitor 640 or other type of display device may also be connected to bus 606 via an interface, such as via video adapter 632. In addition to the monitor 640, the computing system environment 600 may also include other peripheral output devices, not shown, such as speakers and printers.

The computing system environment 600 may also utilize logical connections to one or more computing system environments. Communications between the computing system environment 600 and the remote computing system environment may be exchanged via a further processing device, such a network router 642, that is responsible for network routing. Communications with the network router 642 may be performed via a network interface component 644. Thus, within such a networked environment, e.g., the Internet, World Wide Web, LAN, or other like type of wired or wireless network, it will be appreciated that program modules depicted relative to the computing system environment 600, or portions thereof, may be stored in the memory storage device(s) of the computing system environment 600.

The computing system environment 600 may also include localization hardware 686 for determining a location of the computing system environment 600. In embodiments, the localization hardware 646 may include, for example only, a GPS antenna, an RFID chip or reader, a WiFi antenna, or other computing hardware that may be used to capture or transmit signals that may be used to determine the location of the computing system environment 600.

The computing environment 600, or portions thereof, may comprise one or more components of the system 100 of FIG. 1, in embodiments.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system’s registers and memories and is transformed into other data similarly represented as physical quantities within the computer system memories or registers, or other such information storage, transmission, or display devices as described herein or otherwise understood to one of ordinary skill in the art.

What is claimed is:

1. A method for predicting a next user selection in an electronic user interface, the method comprising:
training a machine learning model according to a training data set, the training data set comprising a plurality of token sets, each token set representative of a respective document accessible through the interface, each token set comprising a plurality of words, each word describing a characteristic of the document, to create a trained model;
receiving, from a user, a sequence of selections of documents;
inputting the sequence of selections to the trained model; and
outputting to the user, in response to the sequence of selections, a predicted next document selection according to an output of the trained model.

2. The method of claim 1, wherein outputting the predicted next document selection comprises one or more of:
displaying a link to the predicted next document in response to a user search;
displaying a link to the predicted next document in response to a user navigation; or
displaying a link to the predicted next document in response to a user click.

3. The method of claim 1, wherein each word describes a characteristic of a subject of the document.

4. The method of claim 1, wherein a plurality of the words describing a characteristic of the document are contained in the document.

5. The method of claim 1, wherein training the machine learning model according to the training data set comprises conducting a training round in which token sets are used independent of user selections of documents.

6. The method of claim 5, wherein the training round is a first training round, wherein training the machine learning model according to the training data set further comprises conducting a second training round in which token sets are used in conjunction with sequences of user selections of documents.

7. The method of claim 1, wherein training the machine learning model according to the training data set comprises conducting a training round in which token sets are used in conjunction with sequences of user selections of documents.

8. A system comprising:
a non-transitory, computer-readable medium storing instructions; and
a processor configured to execute the instructions to:
train a machine learning model according to a training data set, the training data set comprising a plurality of token sets, each token set representative of a respective document accessible through an electronic interface, each token set comprising a plurality of words, each word describing a characteristic of the document, to create a trained model;
receive, from a user, a sequence of selections of documents; input the sequence of selections to the trained model; and
output to the user, in response to the sequence of selections, a predicted next document selection according to an output of the trained model.

9. The system of claim 8, wherein outputting the predicted next document selection comprises one or more of:
displaying a link to the predicted next document in response to a user search;
displaying a link to the predicted next document in response to a user navigation; or
displaying a link to the predicted next document in response to a user click.

10. The system of claim 8, wherein each word describes a characteristic of a subject of the document.

11. The system of claim 8, wherein a plurality of the words describing a characteristic of the document are contained in the document.

12. The system of claim 8, wherein training the machine learning model according to the training data set comprises conducting a training round in which token sets are used independent of user selections of documents.

13. The system of claim 12, wherein the training round is a first training round, wherein training the machine learning model according to the training data set further comprises conducting a second training round in which token sets are used in conjunction with sequences of user selections of documents.

14. The system of claim 8, wherein training the machine learning model according to the training data set comprises conducting a training round in which token sets are used in conjunction with sequences of user selections of documents.

15. A method for predicting a next user selection in an electronic user interface, the method comprising:
training a machine learning model according to a training data set, the training data set comprising a plurality of token sets, each token set representative of a respective document accessible through the interface, each token set comprising a plurality of words, each word describing a characteristic of the document, to create a trained model, wherein training the machine learning model according to the training data set comprises:
conducting a first training round in which token sets are used independent of user selections of documents; and
conducting a second training round in which sequences of user selections of documents are used in conjunction with token sets; and
deploying the trained model to output to a user, in response to a sequence of user selections, a predicted next document selection.

16. The method of claim 15, wherein outputting the predicted next document selection comprises one or more of:
displaying a link to the predicted next document in response to a user search;
displaying a link to the predicted next document in response to a user navigation; or
displaying a link to the predicted next document in response to a user click.

17. The method of claim 15, wherein each word describes a characteristic of a subject of the document.

18. The method of claim 15, wherein a plurality of the words describing a characteristic of the document are contained in the document.

19. The method of claim 15, wherein both the first training round and the second training round comprise a plurality of epochs.

20. The method of claim 15, wherein the first training round is before the second training round.
